(19) United States
(12) Patent Application Publication
(10) Pub. No.: US 2025/0351980 A1
(43) Pub. Date: Nov. 20, 2025

(54) Wall Anchor And Kit For Hanging Objects

(71) Applicant: Oscar Lawrence Buselli, Bessemer, MI (US)

(72) Inventor: Oscar Lawrence Buselli, Bessemer, MI (US)

(21) Appl. No.: 19/290,931

(22) Filed: Aug. 5, 2025

Related U.S. Application Data
(63) Continuation of application No. PCT/US24/14665, filed on Feb. 6, 2024.
(60) Provisional application No. 63/443,734, filed on Feb. 7, 2023.

(51) Int. Cl. A47G 1/17; A01G 5/04; C09J 7/21; F16B 47/00

(52) U.S. Cl. CPC A47G 1/17; A01G 5/04; C09J 7/21; C09J 2301/208; C09J 2400/283; F16B 47/003

(57) ABSTRACT

A fastener for mounting objects to a surface with a twist tie includes a flexible base having opposing first and second surfaces, the flexible base having fixed dimensions with first and second notches formed in the flexible base, the first and second notches extending in a longitudinal direction from opposing edges of the flexible base toward a central portion of the flexible base, each notch having a length that is approximately one third a length of the flexible base. The fastener includes a first adhesive strip and a second adhesive strip each coupled to the second surface of the flexible base, the first and second adhesive strips spaced from each other in a lateral direction thereby forming a channel bounded by the first and second adhesive strips and the second surface of the flexible base, the channel configured to receive at least a portion of a twist tie.

### CROSS-REFERENCE TO RELATED APPLICATIONS

This application is a continuation of International Application No. PCT/US2024/014665 filed Feb. 6, 2024 entitled “Wall Anchor And Kit For Hanging Objects”, which claims the benefit of U.S. Provisional Patent Application No. 63/443,734 filed Feb. 7, 2023 entitled “Flexible Adhesive Base For Twist Tie Fastener And Kit”, each of which is incorporated by reference herein in its entirety.

### BACKGROUND OF THE INVENTION

This disclosure relates to fasteners and, more particularly, to fasteners for temporarily securing heavier weight decorations such as picture frames, garlands, and wreaths consisting of green bows or imitation bows, including those with a wire core, to various surfaces. These decorations are typically used during the holiday season to decorate doors, windows, mantles, or even on a wall surface. The surfaces being decorated consist of various materials, textures, and contours. Examples of these surfaces include: windows, window and door trim, siding, painted drywall, and paneling. Existing fasteners that are available to attach these decorations include: nails, hooks, zip ties, special door brackets for garland, and over the door brackets for wreaths. Nails and screw-in hooks can provide a quick, secure means to attach such decorations but they leave unsightly holes in the surface after the nail or screw-in hook is removed. Zip ties can effectively attach a garland to an open stair banister, encircling the tie around the garland and banister rail. However, a zip tie alone cannot secure an object to a relatively flat surface such as a wall or window. A bracket used for doors fits inside the door jamb and is held in place by using pressure against both side jambs. However, door brackets are relatively expensive and only support the garland across the top of the door, leaving a longer garland hanging unsecured along the sides of the door. Removable hooks are also available with an adhesive base. The Command® line of fasteners to 3M® are available in assorted sizes including a large hook that holds up to 5 pounds. However, some objects, such as heavy wire core garlands, are stiff and are not prone to rest on a hook. Also, when a single hook is used to hang a wreath to a door, some objects are prone to swinging when the door is opened quickly. The same is true for hanging a wreath with the over the door bracket.

Other existing fasteners are adapted for permanent industrial applications to secure cables, wires, tubing, etc. These generally consist of a cable mount or base and a cable tie or zip tie. The mount or base is typically made of rigid plastic with a permanent adhesive on the bottom and a plurality of apertures on top to allow a zip tie to pass through to secure a cable or a wire bundle. However, these types of fasteners are rigid which prevents their easy removal for temporary applications. Trying to remove a flat, rigid base even with a removable adhesive can damage a surface such as painted drywall. Furthermore, these types of fasteners are relatively expensive compared to nails or hook fasteners.

The existing options available for attaching objects to a variety of surfaces do not adequately meet consumer needs. They are generally too expensive, leave holes, or are made of injected molded, rigid plastic making them too expensive and difficult to remove. These fasteners do not fully and efficiently secure the heavier garlands and wreaths to the various surfaces. Therefore, an improved fastener is desired.

### BRIEF SUMMARY OF THE INVENTION

A fastener for mounting objects to a surface with a twist tie includes a flexible base having a first surface and a second surface opposite the first surface, the flexible base having fixed dimensions with first and second notches formed in the flexible base, the first and second notches extending in a longitudinal direction from opposing edges of the flexible base toward a central portion of the flexible base, each notch having a length that is approximately one third a length of the flexible base. The fastener includes a first adhesive strip and a second adhesive strip each coupled to the second surface of the flexible base, the first and second adhesive strips spaced from each other in a lateral direction thereby forming a channel bounded by the first and second adhesive strips and the second surface of the flexible base, the channel configured to receive at least a portion of a twist tie.

The first and second adhesive strips can have a thickness of approximately 0.03125 inches or more. Each of the first and second adhesive strips include respective first and second adhesive surfaces, and the fastener can include a release liner configured to removably cover the first and second adhesive surfaces. The adhesive layer of the first adhesive strip can be coplanar with the adhesive layer of the second adhesive strip when the flexible base is in a first configuration, and the adhesive layer of the first adhesive strip is offset from the adhesive layer of the second adhesive strip when the flexible base is flexed to a second configuration.

The fastener can be configured to be removed from a substrate by peeling the flexible base away from the substrate. The channel can be bounded by the first and second adhesive strips, the second surface of the flexible base, and the substrate when the fastener is coupled to the substrate. In a further embodiment, the fastener can include a twist-tie that can be movable relative to the flexible base when at least a portion of the twist-tie is within the channel. The fastener can include an offset member positioned within the channel, the offset member configured to receive at least one of a wire and a picture frame hanger. The flexible base can be bendable from a first configuration to a second configuration, wherein the flexible base is planar in the first configuration and nonplanar in the second configuration.

In a further embodiment, the fastener can include an elongate fixation element couplable to the flexible base, the elongate fixation element having a length that is greater than the length of the flexible base. The elongate fixation element can be a twist-tie. The elongate fixation element can be foldable to releasably engage itself to hold an object to the first surface of the flexible base. The flexible base can be coupled to the first and second adhesive strips by at least one of an adhesive, a stitch, or a weld. The flexible base can be paperboard.

A method of manufacturing a fastener can include applying first and second adhesive strips to a flexible material, the first and second adhesive strips including an adhesive layer, applying a release liner to the adhesive layer of the first and second adhesive strips, and die-cutting the flexible material, the first and second adhesive strips, and the release liner to form the fastener.

The flexible material can be paperboard. The adhesive layer of the first and second adhesive strips is opposite the flexible material. The die-cutting step can include die-cutting the flexible material, the first and second adhesive strips, and the release liner to form a plurality of fasteners. The method can include placing a plurality of fasteners in a package. The method can include placing a plurality of twist-ties in the package.

In a further embodiment, a fastener can include a flexible base, first and second coupling elements coupled to the flexible base, the first and second coupling elements spaced from each other in a lateral direction. The first and second coupling elements can each include an adhesive layer opposite the flexible base. The flexible base can be bendable from a first configuration to a second configuration, the flexible base planar in the first configuration and nonplanar in the second configuration. The adhesive layer of the first coupling element can be coplanar with the adhesive layer of the second coupling element when the flexible base is in the first configuration. The adhesive layer of the first coupling element can be offset from the adhesive layer of the second coupling element when the flexible base is in the second configuration. The first and second coupling elements can be flexible from a first configuration wherein the adhesive layer of each of the first and second coupling elements is planar to a second configuration wherein the adhesive layer of each of the first and second coupling elements is nonplanar.

In a further embodiment the fastener includes an offset member coupled to the flexible base, the offset member including a first portion that extends away from the first surface and a second portion transverse to the first portion. The first portion can be perpendicular to the second portion. The second portion can be parallel to the flexible base. The first portion can be perpendicular to the flexible base. The offset member can include a third portion transverse to the first portion. The third portion can be parallel to the second portion. The first portion can be perpendicular to each of the second and third portions. The third portion can be coupled to the second surface of the flexible base. The second portion can be spaced from each of the first and second surfaces of the flexible base. The offset member can be configured to hold an object. The offset member can be configured to hold at least one of garland and string lights.

An elongate fixation element can be couplable to the flexible base, the elongate fixation element having a length that can be greater than the length of the flexible base. The elongate fixation element can be foldable to releasably engage itself to hold an object to the flexible base opposite the first and second coupling elements. The elongate fixation element can be at least one of a twist tie, a wire tie, a zip tie, a wire, a string, a ribbon, a rope, or a chain. The elongate fixation element can be spaced from each of the first and second coupling elements when the elongate fixation element is coupled to the flexible base. The elongate fixation element can be movably coupled to the flexible base. At least a portion of the elongate fixation element can be positionable between the second surface of the flexible base and the substrate.

The flexible base can include a first edge and a second edge opposite the first edge, a first notch extending from the first edge toward the second edge and a second notch extending from the second edge toward the first edge. Each of the first and second notches can have a length that is approximately one third of a length of the flexible base. The first and second notches can be equal length. The flexible base, the first coupling element and the second coupling element can be a monolithic construct.

The fastener can include a release liner configured to removably cover the adhesive layers of the first and second coupling elements. A thickness of the flexible base can be less than a thickness of each of the first and second coupling elements. The flexible base can be coupled to the first and second coupling elements by at least one of an adhesive, a stitch, or a weld.

A method of manufacturing a fastener can include applying a first coupling element and a second coupling element to a flexible base such that the first and second coupling elements are spaced from each other in a lateral direction, each of the first and second coupling elements including an adhesive layer opposite the flexible base, and coupling a release liner to the adhesive layer of each of the first and second coupling elements.

The method can include coupling an offset member to the flexible base, the offset member including a first portion that extends away from the first surface and a second portion transverse to the first portion. The method can include die-cutting a plurality of flexible bases from a sheet of material, first and second coupling elements, and the release liner. The method can include packaging the plurality of fasteners in a package with a plurality of flexible elongate fixation elements.

A method of coupling a fastener to a substrate, the fastener having a flexible base, a first coupling element and a second coupling element coupled to the flexible base, and a release liner detachably coupled to the first and second coupling elements, can include detaching the release liner from the first and second coupling elements, flexing the flexible base from a first configuration to a second configuration, fixing the flexible base to the substrate, and coupling a flexible elongate fixation element to the flexible base.

The first and second coupling elements include an adhesive layer and the fixing step can include placing the adhesive layer in contact with the substrate. The method can include placing an object against the flexible base, and securing the object to the flexible base with the flexible elongate fixation element. The securing step can include flexing the flexible base with the object. The flexible base can include a first surface and a second surface opposite the first surface, the second surface positioned between the first surface and the first and second coupling elements, and the coupling step can include positioning a portion of the flexible elongate fixation element between the second surface and the substrate.

The coupling step can include positioning a portion of the flexible elongate fixation element between the second surface and the substrate such that the flexible elongate fixation element can be spaced from the substrate. The method can include applying the adhesive layer to the first and second coupling elements before the release liner can be detachably coupled to the first and second coupling elements.

### BRIEF DESCRIPTION OF THE SEVERAL VIEWS OF THE DRAWINGS

The foregoing summary, as well as the following detailed description of embodiments of the fastener, will be better understood when read in conjunction with the appended drawings of an exemplary embodiment. It should be understood, however, that the invention is not limited to the precise arrangements and instrumentalities shown.

In the drawings:

FIG. 1 is a top perspective view of a fastener including a flexible base, coupling elements, and an elongate fixation element operatively associated with the flexible base in accordance with an exemplary embodiment of the present disclosure;

FIG. 2 is a perspective side view of the flexible base of FIG. 1, with a release liner coupled to the coupling elements;

FIG. 3 is a bottom perspective view of the flexible base and coupling elements of FIG. 1;

FIG. 4A is a top perspective view of the flexible base and coupling elements of FIG. 1 with the flexible base flexed to a second configuration;

FIG. 4B is a top perspective view of the flexible base and coupling elements of FIG. 1 with a corner of the flexible base and one of the coupling elements flexed to a second configuration;

FIG. 5 is a front plan view of the flexible base and the coupling elements of FIG. 1 coupled to a substrate;

FIG. 6 is a top perspective view of the fastener of FIG. 1 coupled to the substrate;

FIG. 7 is a top perspective view of the fastener of FIG. 1 coupled to the substrate with an object secured to the fastener by the elongate fixation element;

FIG. 8 is a top view of a plurality of the fasteners of FIG. 1 in a package;

FIG. 9 is a top perspective view of the flexible base and coupling elements of FIG. 1 with an offset member coupled to the flexible base;

FIG. 10 is a top perspective view of the offset member of FIG. 9;

FIG. 11 is a front perspective view of a fastener including a base and coupling elements in accordance with another exemplary embodiment of the present disclosure;

FIG. 12 is a bottom perspective view of the fastener of FIG. 11; and

FIG. 13 is a schematic illustration of an exemplary embodiment of a manufacturing process for making a fastener including a flexible base having coupling elements.

### DETAILED DESCRIPTION OF THE EXEMPLARY EMBODIMENTS OF THE INVENTION

Disclosed herein are embodiments of a fastener configured to attach an object to a substrate. The fastener can be inexpensive compared to existing fasteners due to its ease of manufacture. The fastener can be made from a flexible material such that the fastener can conform to a variety of surfaces. For example, the fastener can conform to ceilings, walls, corners, glass, furniture, flat surfaces, contoured surfaces, trim, decorative molding, etc.

The flexible base can be manufactured from a lightweight material for ease of handling. The flexible material can be, for example, paper or polyethylene. The flexible material can provide a printable surface for color or other decorative options. The flexible base can be at least one of bendable, foldable, and twistable.

The flexible base can be shaped so that the weight being held by the fastener is concentrated to the center of the fastener. This distributes the weight forces across the entire base thereby causing a shear force across the base rather than a peel force. The coupling mechanism that secures the fastener to a substrate can have greater sheer strength than peel strength. This further allows the base to hold strong yet be easily removed by peeling the flexible base away from the substrate.

The fastener can include adhesive strips that couple the fastener to a substrate. The adhesive strips can be coupled to the flexible base such that the flexible base is spaced from the substrate. The adhesive on the bottom side of the adhesive strips, opposite the flexible base, does not come into contact with the decorating materials, so as not to damage the decorating material.

A twist-tie can be inserted through a space between the flexible base and the substrate after the fastener is coupled to the substrate. The twist-tie can be movable relative to the flexible base after the adhesive strips are coupled to the substrate. The twist-tie can slip relative to the flexible base to allow the twist-tie to settle at its optimal length for holding the decoration. In some examples, the twist-tie is not pre-attached to the flexible base by any means. The twist-tie can be any desired length. The twist-tie can be removed and replaced while the adhesive strips are coupled to the substrate. The twist-ties allow the fastener to hold varying sized objects because they are conformable and have the capacity to go around a single object or multiple objects. The twist-ties have a protective lamination, making them easy to find and handle even with one hand when removing or undoing. The protective lamination also provides safe handling for the user, and protects the decoration from damage. Also, color choices including clear can be offered. The twist-ties allow quick adjustments to be made to decorations that are not placed correctly by simply untwisting the ties, making the adjustments, and re-twisting the ties.

A plurality of fasteners can be applied in a series without any decorations being attached until all the fasteners have been applied. The decoration can then be attached to each fastener and secured by twisting each tie. This is especially helpful when having to work near ceiling heights and holding on to the decoration with one hand and twisting the ties with the other. The fasteners have a low profile making them inconspicuous. The low profile allows the fastener to remain in place between uses even when no decorations are held by the fastener.

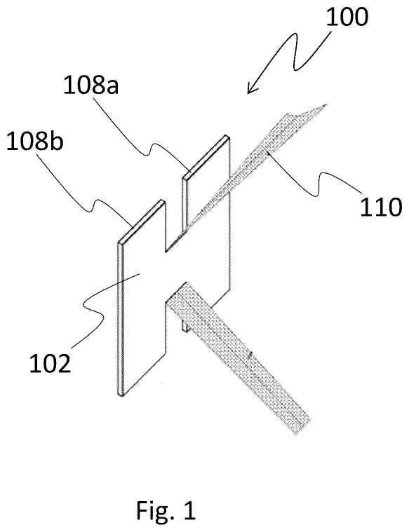

Referring to the drawings in detail, wherein like reference numerals indicate like elements throughout, there is shown in FIGS. 1-10 a fastener, generally designated 100, in accordance with an exemplary embodiment of the present invention. The fastener 100 can be configured to secure an object to a substrate. The fastener 100 can include a flexible base 102 and at least one coupling element to secure the fastener 100 to a substrate. The fastener can include a first coupling element 108a and a second coupling element 108b. The coupling elements 108a and 108b can be adhesive strips coupled to the flexible base 102. The fastener 100 can include an elongate fixation element 110 to secure an object to the fastener 100. For example, the elongate fixation element 110 can be flexible so as to wrap around the object and at least a portion of the flexible base 102 to secure the object to the fastener 100.

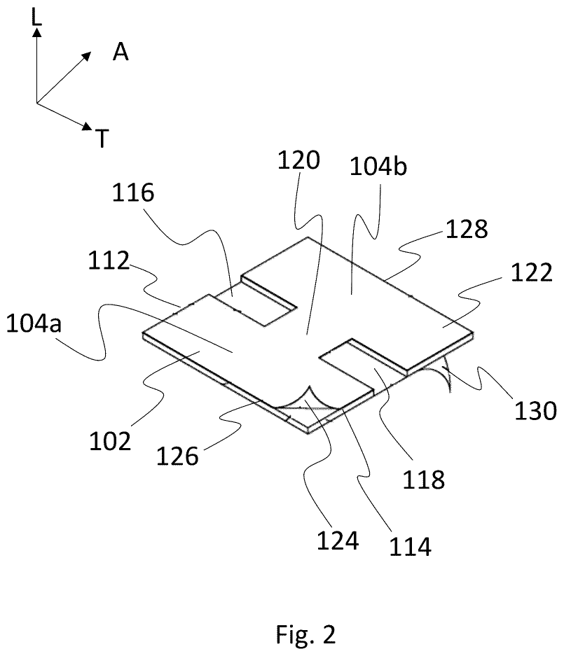

Referring to FIG. 2, the flexible base 102 can be manufactured from a flexible material. Many types of flexible sheet material are available, such as paper, polyethylene, or a combination thereof such as paper bonded to polyethylene. The flexible base 102 can be bendable to conform to a select surface. The flexible base 102 can be bendable from a first configuration to a second configuration. The flexible base 102 can be planar in the first configuration. The flexible base 102 can be nonplanar in the second configuration. The flexible base 102 can transition from the first configuration to the second configuration and then back to the first configuration. The flexible base 102 can bend from the first configuration to the second configuration without elastic deformation.

In some embodiments, the overall size of the fastener 100 is approximately 1.5 inches by 1.5 inches. However, the fastener 100 is not limited to this size or proportion, and can be made larger or smaller depending upon application or consumer need. The flexible base 102 can have fixed dimensions. The flexible base 102 can include a first edge 112 and a second edge 114 opposite the first edge 112 in a longitudinal direction L. The flexible base 102 can include a first surface 122 and a second surface 124 opposite the first surface 122 in a transverse direction T. A portion of the flexible base 102 is shown peeled back in FIG. 2 to illustrate the first and second surfaces 122 and 124 but it should be appreciated that this is not required. The transverse direction T can be perpendicular to the longitudinal direction L. The flexible base 102 can include a first side 126 and a second side 128 opposite the first side 126 in a lateral direction A. The lateral direction A can be perpendicular to each of the transverse and longitudinal directions T and L.

It may be desirable for the fastener 100 to concentrate the weight force from the object being held toward a center of the flexible base 102. The flexible base 102 can include at least one notch such that the elongate fixation element 110 engages the flexible base toward the center of the flexible base 102. This can concentrate the weight force toward a center of the flexible base 102. The flexible base 102 can include a first notch 116 and a second notch 118. The elongate fixation element 110 can engage a central portion 120 of the flexible base 102 between the first and second notches 116 and 118. The first notch 116 can extend from the first edge 112 toward the second edge 114. The second notch 118 can extend from the second edge 114 toward the first edge 112. A central axis of each of the first and second notches 116 and 118 can extend in the longitudinal direction L. Each of the first and second notches 116 and 118 can have a length that is approximately one third the length of the flexible base 102. However, the first and second notches 116 and 118 are not limited to this size or proportion, and can be made larger or smaller depending upon application or consumer need. The first and second notches 116 and 118 can have a width that is approximately one sixth the width of the flexible base 102. The length can be measured in the longitudinal direction L. In some embodiments, the first and second notches 116 and 118 can be equal length. In other embodiments, the first and second notches 116 and 118 are different lengths.

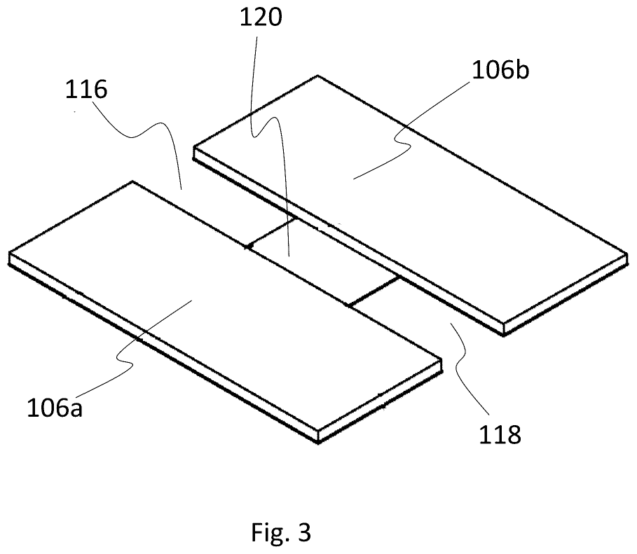

The first and second notches 116 and 118 can be positioned between a first portion 104a and a second portion 104b of the flexible base 102. The central portion 120 can extend between the first and second portions 104a and 104b. The first and second portions 104a and 104b can be configured to coupled to the first and second coupling elements 108a and 108b, respectively. Referring to FIG. 3, the central portion 120 can be a free portion. In other words, the second surface 124 of the central portion 120 does not contact either of the first and second coupling elements 108a and 108b.

In the embodiment shown in FIGS. 1-7, the first and second notches 116 and 118 extend from the first and second edges 112 and 114, respectively. In other embodiments, the notches can be cutouts that do not extend to the edges of the flexible base 102.

It can be desirable to attach the fastener 100 quickly and easily to a substrate without damaging the substrate when attaching or removing the fastener. The first and second coupling elements 108a and 108b can include a pressure sensitive adhesive layer opposite the flexible base 102 so as to adhere the fastener 100 to the substrate. The first and second coupling elements 108a and 108b can be adhesive strips. In other examples, the first and second coupling elements 108a and 108b can be a magnet, suction cup, hook and loop fastener, etc. The first and second coupling elements 108a and 108b can be respectively coupled to the first and second portions 104a and 104b of the flexible base 102. The first and second coupling elements 108a and 108b can be the same width as the first and second portions 104a and 104b of the flexible base 102. The first and second coupling elements 108a and 108b can be the same length as the first and second portions 104a and 104b of the flexible base 102.

In some embodiments, the first and second coupling elements 108a and 108b can be coupled to the second surface 124 of the flexible base 102. The first and second coupling elements 108a and 108b can be coupled to the flexible base 102 by at least one of an adhesive, a stitch, or a weld. In other examples, the flexible base 102, the first coupling element 108a, and the second coupling element 108b are a monolithic construct.

The first and second coupling elements 108a and 108b can be spaced from each other to provide a channel through which the elongate fixation element 110 can be inserted. The first and second coupling elements 108a and 108b can be spaced from each other in the lateral direction L. The first coupling element 108a can have a first thickness, the second coupling element 108b can have a second thickness, and the flexible base 102 can have a base thickness that is less than each of the first and second thicknesses. The first and second thickness can be equal. Each thickness can be measured in the transverse direction T. In one embodiment, the first and second coupling elements 108a and 108b can have a thickness of about 0.03125 inches. However, the thickness of the coupling elements can be selected as desired.

The first and second coupling elements 108a and 108b can be flexible so as to conform to the shape of a desired substrate. The first and second coupling elements 108a and 108b can be manufactured from a flexible foam. In other examples, the first and second coupling elements 108a and 108b can be manufactured from rubber, silicone, nitrile, vinyl, or neoprene. The first and second coupling elements 108a and 108b and the flexible base 102 can simultaneously flex together.

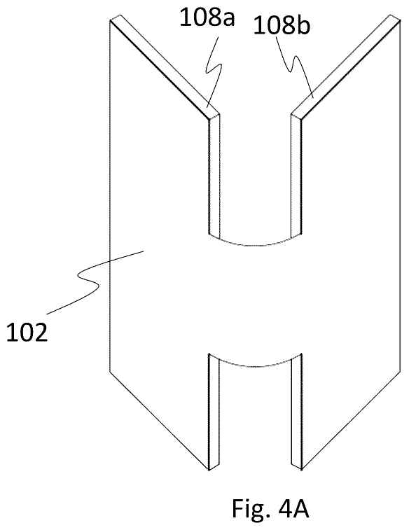

The fastener 100 can transition from a first configuration (FIG. 1) to a second configuration (FIGS. 4A and 4B). In some examples, only the flexible base 102 is nonplanar in the second configuration (FIG. 4A). In other examples, the flexible base 102 and at least one of the first and second coupling elements 108a and 108b are nonplanar in the second configuration (FIG. 4B). The fastener 100 can be placed in the second configuration to conform to the shape of an underlying substrate. In other examples, the fastener 100 transitions to the second configuration as a user peels a corner of one of the coupling elements 108a and 108b away from the substrate. The fastener 100 can return to the first configuration after the fastener 100 is removed from the substrate.

The flexible base 102 can be planar in the first configuration. The flexible base 102 can be nonplanar in the second configuration. The adhesive layer of the first and second coupling elements 108a and 108 can be coplanar when the flexible base 102 is in the first configuration. The adhesive layer of the first and second coupling elements 108a and 108 can be offset when the flexible base 102 is in the second configuration. The adhesive layer of the first and second coupling elements 108a and 108 can be planar when the flexible base 102 is in the first configuration. The adhesive layer of the first and second coupling elements 108a and 108 can be nonplanar when the flexible base 102 is in the second configuration.

The fastener 100 can include a release liner 130, shown partially removed in FIG. 2, that protects the adhesive layer until ready for use. The release liner 130 can be removably coupled to the adhesive layer of the first and second coupling elements 108a and 108b. It should be understood that in some embodiments the adhesive layer covers at least a majority of the bottom surface of the first and second coupling elements 108a and 108b.

The adhesive layer can have a strong resistance to sheer forces. The adhesive layer can have greater sheer strength than peel strength. A user can apply a peel force to the adhesive layer by peeling the fastener 100 away from the substrate. The flexibility of the flexible base 102, first coupling element 108a, and second coupling element 108b allows the fastener to flex as the fastener 100 is peeled away from the substrate.

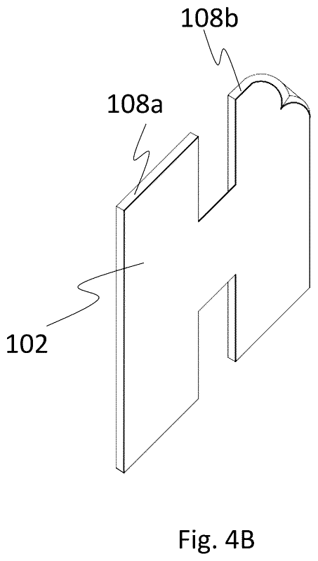

Referring to FIG. 5, the first and second coupling elements 108a and 108b can be adhered to a substrate 134 by removing the release liner 130 and pressing the fastener 100 against the substrate 134. The first and second coupling elements 108a and 108b, the central portion 120 of the flexible base 102, and the substrate 134 can define a channel 132 through which the elongate fixation element 110 can be inserted. The flexible base 102 can be spaced from the substrate 134 when the fastener 100 is coupled to the substrate 134.

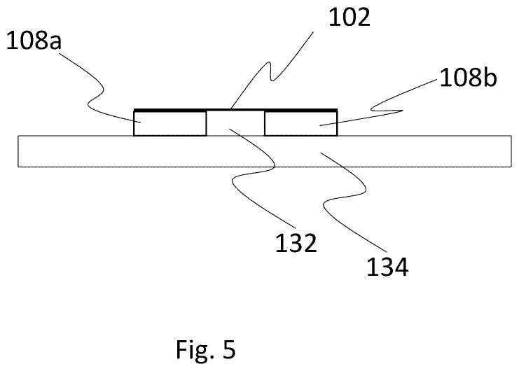

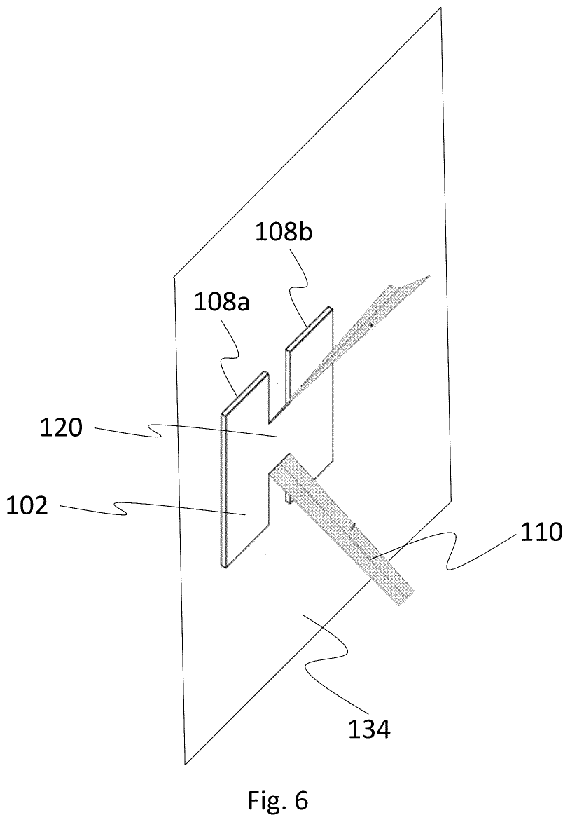

Referring to FIGS. 6 and 7, the elongate fixation element 110 can be inserted through the channel 132 such that the elongate fixation element 110 at least partially wraps around the central portion 120 of the flexible base 102. The elongate fixation element 110 can be foldable to releasably engage itself, thereby holding an object 136 to the flexible base 102 opposite the first and second coupling elements 108a and 108b. The elongate fixation element 110 can be movable relative to the flexible base 102 while the elongate fixation element 110 is wrapped around the central portion 120. For example, the elongate fixation element 110 can be wrapped around the central portion 120 and the object 136 and twisted or tied to itself such that the elongate fixation element 110 can slip relative to the flexible base 102 to allow the elongate fixation element 110 to settle at an optimal position for holding the object 136. The entire elongate fixation element 110 can be movable relative to the flexible base 102 while the elongate fixation element 110 is wrapped around the central portion 120. For example, the elongate fixation element 110 can be rotatable about the central portion 120. The elongate fixation element 110 can be spaced from each of the first and second coupling elements 108a and 108b while the elongate fixation element 110 is coupled to the flexible base 102. At least a portion of the elongate fixation element 110 can be positioned between the second surface 124 of the flexible base 102 and the substrate 134 when the elongate fixation element 110 is coupled to the flexible base 102.

The elongate fixation element 110 can have a length that is greater than a length of the flexible base 102. The length of the elongate fixation element 110 can be selected based on the object 136 held by the fastener 100. The object 136 can be a wreath, garland, bow, etc. The elongate fixation element 110 can be at least one of a twist tie, a wire tie, a zip tie, a wire, a string, a ribbon, a rope, or a chain. The elongate fixation element 110 can be releasably coupled to the object 136 such that different objects can be held by the fastener 100. The elongate fixation element 110 can be coupled to, or decoupled from, the flexible base 102 while the flexible base 102 is coupled to the substrate.

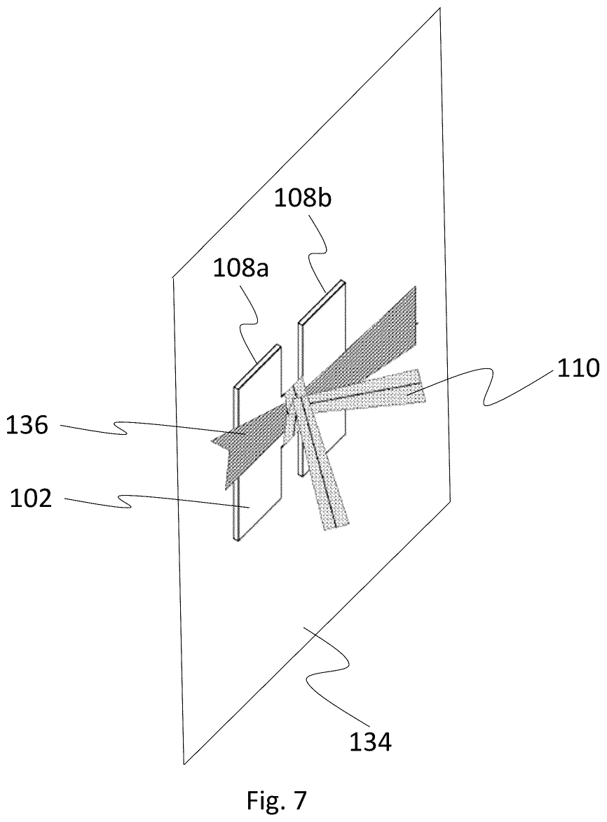

Referring to FIG. 8, a kit 200 can include a plurality of flexible bases 102 and a plurality of elongate fixation elements 110. First and second coupling elements 108a and 108b can be coupled to each of the plurality of flexible bases 102. In some embodiments, the plurality of elongate fixation elements 110 each have the same length. In other embodiments, the plurality of elongate fixation elements 110 are of assorted lengths.

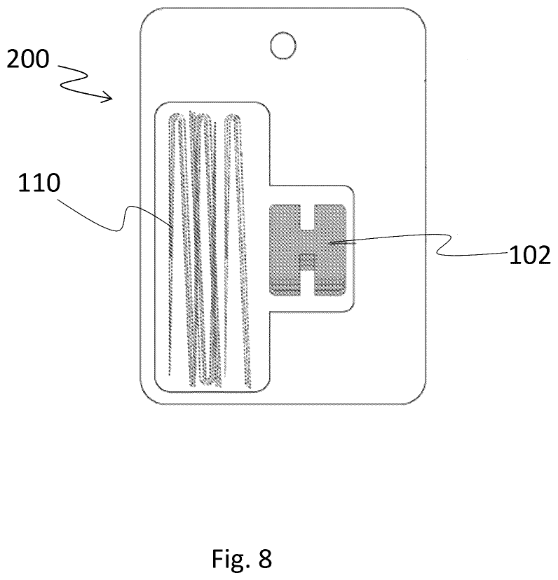

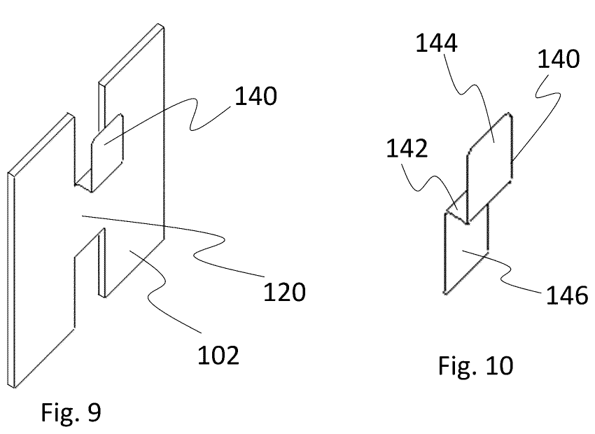

The weight of the object 136 may be supported by the elongate fixation element 110. However, it may be desirable for the object 136 to rest on a portion of the flexible base 102 rather than only be supported by the elongate fixation element 110. Referring to FIGS. 9 and 10, an offset member 140 can be coupled to the flexible base 102. The object 136 can rest on the offset member 140 and the elongate fixation element 110 can secure the object 136 to the flexible base 102. For example, a picture frame hanger or wire can rest on a portion of the offset member 140. The offset member 140 can include a first portion 142, a second portion 144, and a third portion 146. The third portion 146 can be positioned in the channel 132 when the fastener 100 is coupled to the substrate 134. The picture frame hanger or wire can be positioned between the first portion 144 and the first surface 122 of the flexible base 102 such that the picture frame hanger or wire rests on the second portion 146 of the offset member 140. The third portion 146 may contact the substrate 134 during use. The first portion 142 can be perpendicular to the second and third portions 144 and 146. The second portion 144 can be parallel to the third portion 146. At least one of the second and third portions 144 and 146 can be parallel to the flexible base 102. The first portion 142 can be perpendicular to the flexible base 102. The offset member 140 can be a monolithic construct.

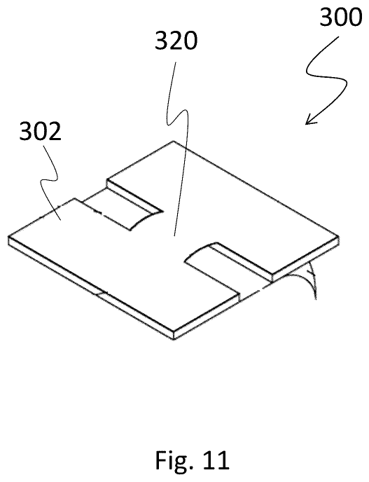

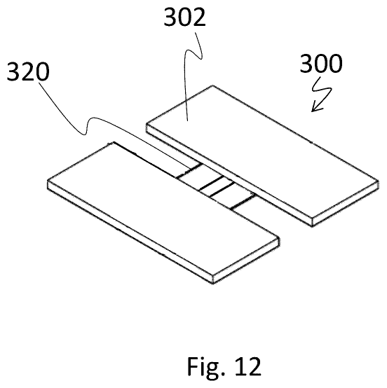

Referring to FIGS. 11 and 12, another embodiment of a fastener 300 is shown. The fastener 300 can be the same as fastener 100 other than the differences that will now be discussed. The fastener 300 can include a base 302 having a greater rigidity than flexible base 102. The base 302 can be manufactured from a durable, non-tear material like sheet metal or plastic. The base 302 can include an arched central portion 320 to provide additional clearance for a thicker elongate fixation element. For example, a zip tie or cable tie can be used with base 302. The central portion 320 can be reinforced by hemming or folding the material from the notches over on itself as shown in FIG. 12. Hemming the central portion 320 can also reduce or eliminate sharp edges that could exist if the notches were die-cut without hemming.

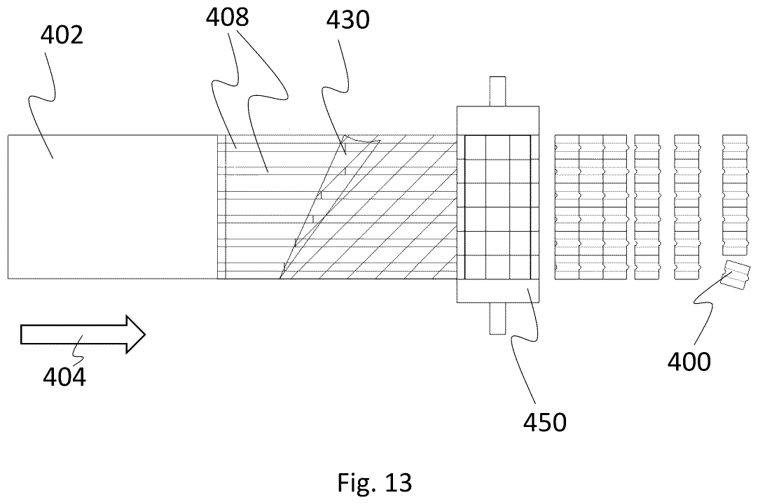

Referring to FIG. 13, one embodiment of a method of manufacturing a fastener 400 is shown. The fastener 400 can be the same as fastener 100. The method can include applying a plurality of adhesive strips 408 to a flexible base 402. The adhesive strips 408 can be applied as the flexible base 402 moves in a machine direction 404. The adhesive strips 408 can include an adhesive layer opposite the flexible base 402. A release liner 430 can be applied to the adhesive layer of the adhesive strips 408. A roller die cutting station 450 can cut each of the flexible base 402, the adhesive strips 408, and the release liner 430 to form at least one fastener 400. The roller die cutting station 450 can form a plurality of fasteners 400 from the flexible base 402, the adhesive strips 408, and the release liner 430.

For purposes of this disclosure, the term “coupled” means the joining of two components directly or indirectly to one another. Such joining may be stationary in nature moveable in nature. Such joining may be achieved with the two components and any additional intermediate members being integrally formed as a single unitary body with one another or the two components and any additional member being attached to one another. Such adjoining may be permanent in nature or alternatively be removable or releasable in nature.

Although the foregoing description of a fastener has been shown and described with reference to particular embodiments and applications thereof, it has been presented for purposes of illustration and description and is not intended to be exhaustive or to limit the disclosure to the particular embodiments and applications disclosed. It will be apparent to those having ordinary skill in the art that a number of changes, modifications, variations, or alterations to the fastener as described herein may be made, none of which depart from the spirit or scope of the present disclosure. The particular embodiments and applications were chosen and described to provide the best illustration of the principles of the fastener and its practical application to thereby enable one of ordinary skill in the art to utilize the fastener in various embodiments and with various modifications as are suited to the particular use contemplated. All such changes, modifications, variations, and alterations should therefore be seen as being within the scope of the present disclosure as determined by the appended claims when interpreted in accordance with the breadth to which they are fairly, legally, and equitably entitled.

It will be appreciated by those skilled in the art that changes could be made to the exemplary embodiments shown and described above without departing from the broad inventive concepts thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and various features of the disclosed embodiments may be combined. The words “right”, “left”, “lower” and “upper” designate directions in the drawings to which reference is made. The words “inwardly” and “outwardly” refer to directions toward and away from, respectively, the geometric center of the fastener. Unless specifically set forth herein, the terms “a”, “an” and “the” are not limited to one element but instead should be read as meaning “at least one”. As used herein, the word “approximately” can mean+/−1%, +/−5%, +/−10%, or +/−15% of a stated value.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the methods of the present invention do not rely on the particular order of steps set forth herein, the particular order of the steps should not be construed as limitation on the claims. Any claims directed to the methods of the present invention should not be limited to the performance of their steps in the order written, and one skilled in the art can readily appreciate that the steps may be varied and still remain within the spirit and scope of the present invention.

I/We claim:

1. A fastener that couples objects to a substrate with a twist tie comprising:
a flexible base having a first surface and a second surface opposite the first surface, the flexible base having fixed dimensions with first and second notches formed in the flexible base, the first and second notches extending in a longitudinal direction from opposing edges of the flexible base toward a central portion of the flexible base, each notch having a length that is approximately one third a length of the flexible base, the flexible base comprising paperboard;
a twist tie couplable to and decouplable from the flexible base when the fastener is coupled to the substrate; and
a first adhesive strip and a second adhesive strip each coupled to the second surface of the flexible base, the first and second adhesive strips spaced from each other in a lateral direction thereby forming a channel bounded by the first and second adhesive strips and the second surface of the flexible base, the channel configured to receive at least a portion of the twist tie.

2. The fastener of claim 1, wherein a thickness of the first and second adhesive strips is at least approximately 0.03125 inches.

3. The fastener of claim 1, wherein each of the first and second adhesive strips include respective first and second adhesive layers, and
wherein the fastener further comprises a release liner configured to removably cover the first and second adhesive layers.

4. The fastener of claim 3, wherein the adhesive layer of the first adhesive strip is coplanar with the adhesive layer of the second adhesive strip when the flexible base is in a first configuration, and
wherein the adhesive layer of the first adhesive strip is offset from the adhesive layer of the second adhesive strip when the flexible base is flexed to a second configuration.

5. The fastener of claim 1, wherein the fastener is configured to be removed from a substrate by peeling the flexible base away from the substrate.

6. The fastener of claim 1, wherein the channel is bounded by the first and second adhesive strips, the second surface of the flexible base, and the substrate when the fastener is coupled to the substrate.

7. The fastener of claim 1, wherein the twist-tie is movable relative to the flexible base when at least a portion of the twist-tie is within the channel.

8. The fastener of claim 1, further comprising an offset member positioned within the channel, the offset member configured to receive at least one of a wire and a picture frame hanger.

9. The fastener of claim 1, wherein the flexible base is bendable from a first configuration to a second configuration, wherein the flexible base is planar in the first configuration and nonplanar in the second configuration.

10. The fastener of claim 1, wherein the twist tie has a length that is greater than the length of the flexible base.

11. The fastener of claim 10, wherein the twist tie is rotatable relative to the flexible base when the fastener is coupled to the substrate.

12. The fastener of claim 10, wherein the elongate fixation element is foldable to releasably engage itself to hold an object to the first surface of the flexible base.

13. The fastener of claim 1, wherein the flexible base is coupled to the first and second adhesive strips by at least one of an adhesive, a stitch, or a weld.

14. The fastener of claim 1, wherein the flexible base comprises at least one of paperboard, polyethylene, or plastic.

15. A method of manufacturing a fastener comprising:
applying first and second adhesive strips to a flexible material, the first and second adhesive strips including an adhesive layer;
applying a release liner to the adhesive layer of the first and second adhesive strips; and
die-cutting the flexible material, the first and second adhesive strips, and the release liner to form the fastener.

16. The method of claim 15, wherein the flexible material comprises paperboard.

17. The method of claim 15, wherein the adhesive layer of the first and second adhesive strips is opposite the flexible material.

18. The method of claim 15, wherein the die-cutting step includes die-cutting the flexible material, the first and second adhesive strips, and the release liner to form a plurality of fasteners.

19. The method of claim 15, further comprising placing a plurality of fasteners in a package.

20. The method of claim 19, further comprising placing a plurality of twist-ties in the package.
